(19) United States
(12) Patent Application Publication
(10) Pub. No.: US 2023/0205203 A1
(43) Pub. Date: Jun. 29, 2023

(54) REMOTE DRIVING SYSTEM

(71) Applicant: LEAR CORPORATION, Southfield, MI (US)

(72) Inventors: Samer RAJAB, Novi, MI (US); Radovan MIUCIC, Beverly Hills, MI (US)

(73) Assignee: LEAR CORPORATION, Southfield, MI (US)

(21) Appl. No.: 17/561,020

(22) Filed: Dec. 23, 2021

(51) Int. Cl. G05D 1/00; H04N 5/232; H04N 7/18

(52) U.S. Cl. CPC G05D 1/0038; H04N 5/23235; H04N 7/18; G05D 1/0016

(57) ABSTRACT

A vehicle system and method for remotely controlling a host vehicle. The vehicle system is provided with at least one sensor for generating high-resolution data indicative of an environment external to a host vehicle, and a processor in communication with the at least one sensor. The processor is programmed to generate low-resolution data based on the high-resolution data, and to control at least one vehicle actuator based on a driver command. At least one transceiver provides the low-resolution data to, and receives the driver command from, a remote driving system.

### TECHNICAL FIELD

One or more embodiments relate to a vehicle system and method for controlling a vehicle from a remote location.

### BACKGROUND

An autonomous vehicle is a vehicle that includes cameras and/or sensors for monitoring its external environment and moving with little or no input from a driver within the vehicle. The autonomous vehicle may include one or more vehicle systems that monitor external environment data from the sensors and generate driving commands to control vehicle functions. The autonomous vehicle may also communicate with a remote system for monitoring the external environment data and generating driving commands. The vehicle sensors may be high quality sensors resulting in high-bandwidth communication between the autonomous vehicle and the remote system. For example, a 5G Automotive Alliance (5GAA) study estimates a 36 megabits per second (Mbps) uplink bandwidth for remote driving based on four live video streams at 8 Mbps and 4 Mbps of sensors data.

### SUMMARY

In one embodiment, a vehicle system is provided with at least one sensor for generating high-resolution data indicative of an environment external to a host vehicle, and a processor in communication with the at least one sensor. The processor is programmed to generate low-resolution data based on the high-resolution data, and to control at least one vehicle actuator based on a driver command. At least one transceiver provides the low-resolution data to, and receives the driver command from, a remote driving system.

In another embodiment, a method is provided for remotely controlling a vehicle. High-resolution data indicative of an environment external to a host vehicle is received. Low-resolution data is generated based on the high-resolution data. The low-resolution data is provided to a remote driving system. A driver command is received from the remote driving system. At least one vehicle actuator is controlled based on the driver command.

In yet another embodiment, an autonomous vehicle system is provided with at least one sensor for generating high-resolution data indicative of an environment external to a host vehicle and a processor in communication with the at least one sensor. The processor is programmed to generate low-resolution data based on the high-resolution data. At least one transceiver transmits the low-resolution data and receives a driver command from a remote driving system based on the low-resolution data. The processor is further programmed to control at least one vehicle actuator based on the driver command.

### BRIEF DESCRIPTION OF THE DRAWINGS

FIG. 1 is a top schematic view of a vehicle system in communication with a remote system for remotely controlling a host vehicle.

FIG. 2 is a detailed schematic view illustrating communication between the vehicle system and the remote driving system, according to one or more embodiments.

FIG. 3 is a front view of a user interface of the remote driving system, illustrating a first simulated environment.

FIG. 4 is another front view of the user interface of the remote driving system, illustrating a second simulated environment.

FIG. 5 is a flow chart illustrating a method for remotely controlling a host vehicle.

### DETAILED DESCRIPTION

As required, detailed embodiments are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

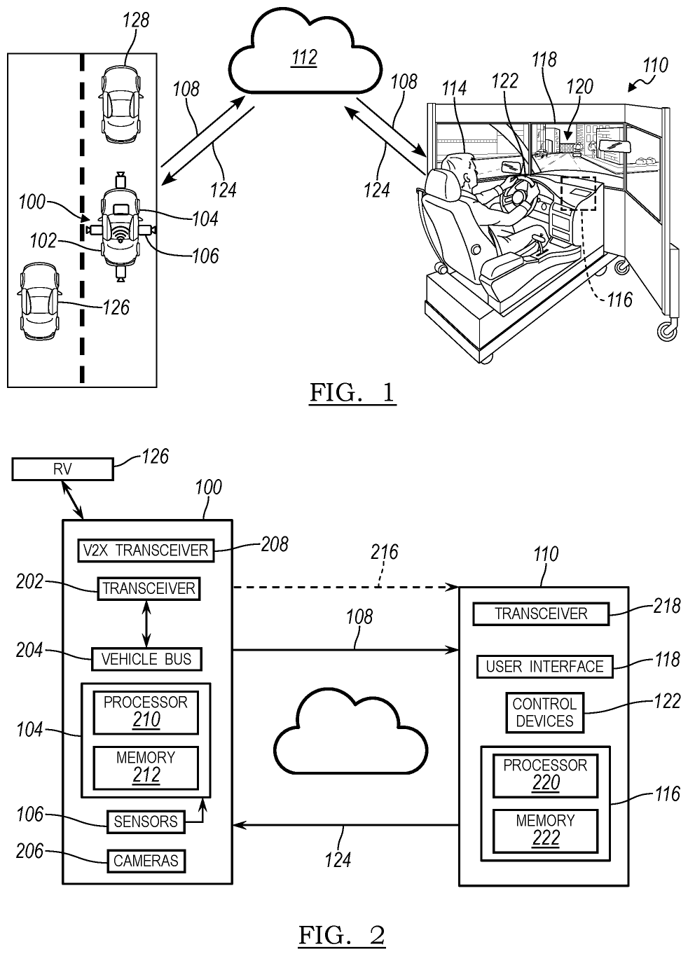

With reference to FIG. 1, a vehicle system for remotely controlling a host vehicle is illustrated in accordance with one or more embodiments and is generally referenced by numeral 100. The vehicle system 100 is depicted within a host vehicle (HV) 102. The vehicle system 100 includes a controller 104 and at least one sensor 106. The sensor 106 monitors the environment external to the HV 102 and generates high-resolution data of the environment, e.g., the presence of vehicles and objects. The controller 104 generates low-resolution data 108 based on the high-resolution data, and provides the low-resolution data 108 to a remote driving system 110 over a network 112.

The remote driving system 110 presents the low-resolution data 108 to a remote driver 114 for remotely controlling the HV 102. The remote driving system 110 includes a remote controller 116 and a user interface 118. The remote controller 116 generates a simulated environment 120 on the user interface 118 based on the low-resolution data 108. The remote driving system 110 includes one or more driver control devices 122, e.g., a steering wheel, a gas pedal, and a brake pedal, for the remote driver 114 to manually control based on the simulated environment 120. The driver control devices 122 generate driver command signals 124 based on the remote driver's manual input, which the remote controller 116 transmits to the vehicle system 100 for remotely controlling the HV 102. The vehicle system 100 uses less bandwidth than existing systems by converting the high-resolution data to low-resolution data before transmitting it to the remote driving system 110.

The HV 102 is illustrated travelling proximate to two remote vehicles (RVs): a first RV 126 and a second RV 128. The HV 102 may communicate with one or more of the RVs by vehicle-to-vehicle (V2V) communication. The HV 102 may also communicate with a motorcycle (not shown) by vehicle-to-motorcycle (V2M) communication and a structure (not shown) by vehicle-to-infrastructure (V2I) communication.

Referring to FIG. 2, the vehicle system 100 includes a transceiver 202 that is connected to the controller 104 for communicating with other systems of the HV 102. The transceiver 202 may receive input that is indicative of present operating conditions of various systems of the HV 102, e.g., an engine, transmission, navigation system, brake systems, etc. (not shown). Each input may be a signal transmitted directly between the transceiver 202 and the corresponding vehicle system, or indirectly as data over a vehicle communication bus 204, e.g., a CAN bus. For example, the transceiver 202 may receive input such as vehicle speed, turn signal status, brake position, vehicle position, and steering angle over the vehicle communication bus 204.

The transceiver 202 may also receive input that is indicative of the environment external to the HV 102. For example, the sensors 106 of the HV 102 may include light detection and ranging (Lidar) sensors, for determining the location of objects external to the HV 102. The sensors 106 may also include one or more cameras 206, e.g., high-resolution cameras, for monitoring the external environment. In one embodiment, the vehicle system 100 includes four high-resolution cameras 206, each of which provide a live video stream at approximately 8 Mbps.

The vehicle system 100 also includes a V2X transceiver 208 that is connected to the controller 104 for communicating with other vehicles and structures. For example, the vehicle system 100 of the HV 102 may use the V2X transceiver 208 for communicating directly with the first RV 126 by vehicle-to-vehicle (V2V) communication, a sign (not shown) by vehicle-to-infrastructure (V2I) communication, or a motorcycle (not shown) by vehicle-to-motorcycle (V2M) communication.

The vehicle system 100 may use WLAN technology to form a vehicular ad-hoc network as two V2X devices come within each other's range. This technology is referred to as Dedicated Short-Range Communication (DSRC), which uses the underlying radio communication provided by IEE 802.11p. The range of DSRC is typically about 300 meters, with some systems having a maximum range of about 1000 meters. DSRC in the United States typically operates in the 5.9 GHz range, from about 5.85 GHz to about 5.925 GHz, and the typical latency for DSRC is about 50 ms. Alternatively, the vehicle system 100 may communicate with another V2X device using Cellular V2X (C-V2X), Long Term Evolution V2X (LTE-V2X), or New Radio Cellular V2X (NR C-V2X), each of which may use the network 112, e.g., a cellular network. Additionally, the network 112 can be 5G cellular network connected to cloud or 5G cellular/V2X network that utilize edge computing platforms.

Each V2X device may provide information indictive of its own status to other V2X devices. Connected vehicle systems and V2V and V2I applications using DSRC rely on the Basic Safety Message (BSM), which is one of the messages defined in the Society of Automotive standard J 2735, V2X Communications Message Set Dictionary, July 2020. The BSM is broadcast from vehicles over the 5.9 GHz DSRC band, and the transmission range is on the order of 1,000 meters. The BSM consists of two parts. BSM Part 1 contains core data elements, including vehicle position, heading, speed, acceleration, steering wheel angle, and vehicle classification (e.g., passenger vehicle or motorcycle) and is transmitted at an adjustable rate of about 10 times per second. BSM Part 2 contains a variable set of data elements drawn from an extensive list of optional elements. They are selected based on event triggers (e.g., ABS activated) and are added to Part 1 and sent as part of the BSM message, but are transmitted less frequently in order to conserve bandwidth. The BSM message includes only current snapshots (with the exception of path data which is itself limited to a few second's worth of past history data). As will be discussed in further detail herein, it is understood that any other type of V2X messages can be implemented, and that V2X messages can describe any collection or packet of information and/or data that can be transmitted between V2X communication devices. Further, these messages may be in different formats and include other information. Each V2X device may also provide information indictive of the status of another vehicle or object in its proximity.

Although the controller 104 is described as a single controller, it may contain multiple controllers, or may be embodied as software code within one or more other controllers. The controller 104 includes a processing unit, or processor 210, that may include any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. The controller 104 also includes memory 212, or non-transitory computer-readable storage medium, that is capable of executing instructions of a software program. The memory 212 may be, but is not limited to, an electronic storage device, a magnetic storage device, an optical storage device, an electromagnetic storage device, a semi-conductor storage device, or any suitable combination thereof. In general, the processor 210 receives instructions, for example from the memory 212, a computer-readable medium, or the like, and executes the instructions. The controller 104, also includes predetermined data, or “look up tables” that are stored within memory, according to one or more embodiments.

The controller 104 converts the high-resolution data to low-resolution data 108. The processor 210 compresses or converts high-resolution video data from the cameras 206 to the low-resolution data 108. In one embodiment, the processor 210 generates the low-resolution data 108 in an extensible markup language file (XML) using the OpenSCENARIO software. In one or more embodiments, the low-resolution data 108 includes sensor data. The transceiver 202 transmits the low-resolution data 108 to the remote driving system 110, e.g., over the network 112. In one or more embodiments, the vehicle system 100 also provides low-quality video feed 216 to the remote driving system 110. The low-resolution data 108 combined with the low-quality video feed 216 requires low bandwidth, e.g., less than 10 Mbps, as compared to a conventional system, such as that describe in the 5G Automotive Alliance (SGAA) study that estimates a 36 Mbps uplink bandwidth for remote driving based on four live video streams at 8 Mbps and 4 Mbps of sensors data.

The remote driving system 110 includes a transceiver 218 for receiving the low-resolution data 108 and the low-quality video feed 216. The remote controller 116 includes a processor 220 and memory 222 that receive the low-resolution data 108 and the low-quality video feed 216 from the transceiver 218. The processor 220 generates the simulated environment 120 on the user interface 118 based on the low-resolution data 108.

This simulated environment 120 enables the remote driver 114 to visualize the driving environment and then to provide driving feedback, i.e., the driver command signals 124, using the driver control devices 122, e.g., a steering wheel, a brake pedal and an accelerator pedal. The driver command signals 124 may include target waypoints, speed, acceleration and controller parameters. The transceiver 218 transmits the driver command signals 124 to the vehicle system 100. The controller 104 may then provide the commands to the vehicle actuators or systems. In any case, the two-way wireless communications between the remote driving system 110 and the vehicle system 100 is done using the preformatted communication, such as OpenSCENARIO xml format, according to one or more embodiments.

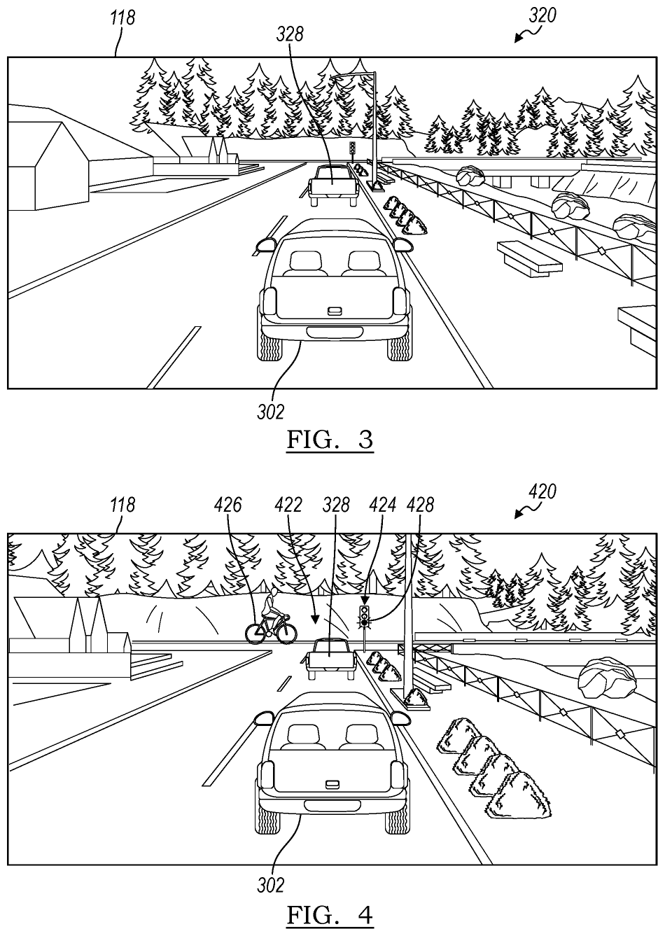

FIG. 3 illustrates an example simulated environment 320 displayed on the user interface 118. The simulated environment 320 illustrates an HV image 302 and a second RV image 328 representing the HV 102 trailing behind the second RV 128 as shown in FIG. 1.

FIG. 4 illustrates another example simulated environment 420 displayed on the user interface 118. The simulated environment 420 illustrates the HV image 302 trailing the second RV image 328 and approaching an intersection 422 with a streetlight 424. A person on a bicycle 426 is riding through the intersection 422 in front of the second RV 328. The streetlight 424 includes a green light 428 that is illuminated, as indicated by the lines extending from the green light 428. Although the green light 428 is illuminated, the remote driver 114 may control a driver control device 122, e.g., a brake pedal, to start decelerating the HV 102, e.g., by controlling a driver control device 122 to send a driver command signal 124 indicative of braking, because of the bicycle 426 in the intersection 422.

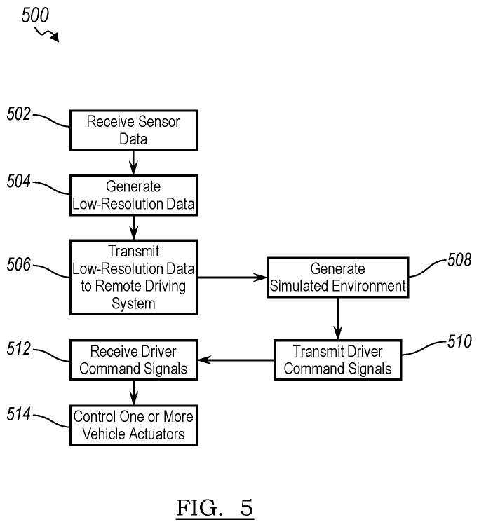

With reference to FIG. 5, a flow chart depicting a method for remotely controlling a host vehicle is illustrated in accordance with one or more embodiments and is generally referenced by numeral 500. The method 500 is implemented using software code that is executed by the controller 104 and the remote controller 116 according to one or more embodiments. While the flowchart is illustrated with a number of sequential steps, one or more steps may be omitted and/or executed in another manner without deviating from the scope and contemplation of the present disclosure.

At step 502, the controller 104 receives high-resolution data of the environment external to the HV 102, e.g., from the sensor 106 or camera 206. At step 504, the controller 104 generates low-resolution data 108 based on the high-resolution data, e.g., using Open Scenerio software. At step 506, the controller 104 provides the low-resolution data 108 to the remote controller 116 of the remote driving system 110, e.g., over the network 112.

At step 508 the remote controller 116 generates the simulated environment 120 on the user interface 118 based on the low-resolution data 108. The remote driver manipulates the driver control devices 122 based on the simulated environment 120 to generate the driver command signals 124, which are provided to the remote controller 116. At step 510, the remote controller 116 transmits the driver command signals, which the controller 104 of the vehicle system 100 receives at step 512. At step 514, the controller 104 controls one or more vehicle actuators based on the driver command signals.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A vehicle system comprising:
at least one sensor for generating high-resolution data indicative of an environment external to a host vehicle;
a processor in communication with the at least one sensor and programmed to:
generate low-resolution data based on the high-resolution data, and
control at least one vehicle actuator based on a driver command; and
at least one transceiver for providing the low-resolution data to, and receiving the driver command from, a remote driving system.

2. The vehicle system of claim 1, wherein the at least one sensor comprises at least one camera, and wherein the high-resolution data is indicative of a video feed.

3. The vehicle system of claim 2, wherein the at least one camera comprises at least four cameras, wherein each camera is adapted to provide a live video stream of approximately eight megabits per second.

4. The vehicle system of claim 1, wherein the low-resolution data further comprises at least one of an extensible markup language file and low-quality video.

5. The vehicle system of claim 1, wherein the processor is further programmed to generate low-resolution data by compressing the high-resolution data.

6. The vehicle system of claim 1, wherein the low-resolution data is less than one-third the size of the high-resolution data.

7. An autonomous vehicle system comprising:
a vehicle system according to claim 1; and
the remote driving system, the remote driving system further comprising:
a display, and
a remote processor for generating a simulated environment on the display based on the low-resolution data.

8. The autonomous vehicle system of claim 7, wherein the remote driving system further comprises a driver control device to generate the driver command.

9. The autonomous vehicle system of claim 8, wherein the driver control device is adapted to generate the driver command in response to manual input from a remote driver viewing the display.

10. The autonomous vehicle system of claim 8, wherein the driver control device comprises at least one of a steering wheel, a gas pedal, and a brake pedal.

11. A method for remotely controlling a vehicle, comprising:
receiving high-resolution data indicative of an environment external to a host vehicle;
generating low-resolution data based on the high-resolution data;
providing the low-resolution data to a remote driving system;
receiving a driver command from the remote driving system; and
controlling at least one vehicle actuator based on the driver command.

12. The method of claim 11, further comprising generating a simulated environment on a display in response to the low-resolution data.

13. The method of claim 12, further comprising receiving the driver command from a driver control device in response to manual input from a remote driver viewing the simulated environment on the display.

14. The method of claim 11, wherein generating the low-resolution data based on the high-resolution data, further comprises compressing the high-resolution data.

15. An autonomous vehicle system comprising:
at least one sensor for generating high-resolution data indicative of an environment external to a host vehicle;
a processor in communication with the at least one sensor and programmed to generate low-resolution data based on the high-resolution data;
at least one transceiver for transmitting the low-resolution data, and receiving a driver command from a remote driving system based on the low-resolution data; and
wherein the processor is further programmed to control at least one vehicle actuator based on the driver command.

16. The autonomous vehicle system of claim 15, further comprising:
a display mounted remote from the host vehicle;
a remote processor programmed to generate a simulated environment on the display based on the low-resolution data; and
a driver control device to generate the driver command in response to manual input from a remote driver viewing the simulated environment on the display.

17. The autonomous vehicle system of claim 16, wherein the driver control device comprises at least one of a steering wheel, a gas pedal, and a brake pedal.

18. The autonomous vehicle system of claim 15, wherein the at least one sensor comprises at least one camera, and wherein the high-resolution data is indicative of a video feed.

19. The autonomous vehicle system of claim 15, wherein the processor is further programmed to generate low-resolution data by compressing the high-resolution data.

20. The autonomous vehicle system of claim 15, wherein the low-resolution data is less than one-third the size of the high-resolution data.
